(19) United States
(12) Patent Application Publication
(10) Pub. No.: US 2023/0109209 A1
(43) Pub. Date: Apr. 6, 2023

(54) METHOD AND APPARATUS FOR SIGNALING NET-ZERO WORKFLOW MODIFICATIONS ON CLOUD PLATFORMS

(71) Applicant: TENCENT AMERICA LLC, Palo Alto, CA (US)

(72) Inventor: Iraj SODAGAR, Los Angeles, CA (US)

(73) Assignee: TENCENT AMERICA LLC, Palo Alto, CA (US)

(21) Appl. No.: 17/701,049

(22) Filed: Mar. 22, 2022

Related U.S. Application Data
(60) Provisional application No. 63/252,422, filed on Oct. 5, 2021.

(51) Int. Cl. G06F 9/48

(52) U.S. Cl. CPC G06F 9/48; H04L 67/10

(57) ABSTRACT

A method and an apparatus for signaling workflow modifications in a network based media processing (NBMP) workflow. The method includes obtaining a NBMP workflow, generating a modified NBMP workflow by adding tasks configured to perform predetermined functions to a work description of the NBMP workflow, wherein the tasks do not change an output of the NBMP workflow, and signaling the tasks of the modified NBMP workflow based on a task group object. Tasks are included in a task group and are determined based on a group identification, a task identification, a group mode, and a net-zero flag of the task group object. Based on a status of the net-zero flag, the one or more tasks in the task group may be removed from the modified NBMP workflow without effecting the output of the NBMP workflow. Multiple task groups may be included in the modified NBMP workflow and removed independently.

### CROSS-REFERENCE TO RELATED APPLICATION

This application is based on and claims priority to U.S. Provisional Pat. Application No. 63/252,422, filed on Oct. 5, 2021, the disclosure of which is incorporated by reference herein in its entirety.

### FIELD

Embodiments of the present disclosure relate to signaling tasks added to a workflow to make it more appropriate for splitting the workflow into two or more sub-workflows. Such tasks, while making the splitting feasible, do not have any functional significance in the net process performed by the workflow and therefore have an impact of net-zero in terms of processing of the data.

### BACKGROUND

A network and cloud platform may be used to run various applications. The Network Based Media Processing (NBMP) standard provides a specification for defining, instantiating, and running workflows on cloud platforms. The NBMP standard also includes split-rendering functionalities. However, the split-rendering functionality of the NBMP standard does not identify added tasks to a workflow needed for splitting the workflow. As such, the workflow may not be efficiently split. The present disclosure solves this issue and describes the added task that help efficiently split the workflow into sub-workflows.

### SUMMARY

One or more example embodiments of the present disclosure provide a method and an apparatus for signaling net-zero workflow modifications on cloud platform.

According to embodiments, there is provided a method for signaling NBMP workflow modifications when a workflow split is required. The method may include obtaining a NBMP workflow, generating a modified NBMP workflow by adding one or more tasks to a work description of the NBMP workflow, and signaling the one or more tasks of the modified NBMP workflow based on a task group object. The one or more tasks of the method may be configured to perform predetermined functions, and the one or more tasks do not change an output of the NBMP workflow.

According to embodiments, there is provided an apparatus for signaling NBMP workflow modifications when a workflow split is required. The apparatus may include at least one memory storing instructions and at least one processor configured to read the program code and operate as instructed by the program code. The program code may include obtaining code configured to cause the at least one processor to obtain a NBMP workflow, generating code configured to cause the at least one processor to generate a modified NBMP workflow by adding one or more tasks to a work description of the NBMP workflow, and signaling code configured to cause the at least one processor to signal the one or more tasks of the modified NBMP workflow based on a task group object, wherein the one or more tasks are configured to perform predetermined functions, and wherein the one or more tasks do not change an output of the NBMP workflow.

According to one or more embodiments, a non-transitory computer-readable medium storing computer code may be provided. The computer code may be configured to, when executed by at least one processor, cause the at least one processor to obtain a NBMP workflow, generate a modified NBMP workflow by adding one or more tasks to a work description of the NBMP workflow, and signal the one or more tasks of the modified NBMP workflow based on a task group object, wherein the one or more tasks are configured to perform predetermined functions, and wherein the one or more tasks do not change an output of the NBMP workflow.

Additional aspects will be set forth in part in the description that follows and, in part, will be apparent from the description, or may be realized by practice of the presented embodiments of the disclosure.

### BRIEF DESCRIPTION OF THE DRAWINGS

The above and other aspects, features, and aspects of embodiments of the disclosure will be more apparent from the following description taken in conjunction with the following accompanying drawings.

FIG. 1 is a schematic illustration of a communication system, according to one or more embodiments.

FIG. 2 is a simplified example illustration of a streaming environment, according to one or more embodiments.

FIG. 3 is a block diagram of an NBMP system, according to one or more embodiments.

FIG. 4 is an example diagram of tasks added to a workflow, according to one or more embodiments.

FIG. 5 is a block diagram of an example process for signaling net-zero tasks in a modified workflow, according to one or more embodiments.

FIG. 6 is a block diagram of an example of computer code for signaling net-zero tasks in a modified workflow, according to one or more embodiments.

### DETAILED DESCRIPTION

The present disclosure relates to a method and an apparatus for signaling modifications in a network based media processing (NBMP) workflow without effecting the output of the workflow.

Embodiments of the present disclosure are described comprehensively with reference to the accompanying drawings. However, the examples of implementations may be implemented in various multiple forms, and the disclosure should not be construed as being limited to the examples described herein. Conversely, the examples of implementations are provided to make the technical solution of the disclosure more comprehensive and complete, and comprehensively convey the idea of the examples of the implementations to a person skilled in the art. The accompanying drawings are merely example illustrations of the disclosure and are not necessarily drawn to scale. A same reference numeral in the accompanying drawings represents same or similar components, and therefore repeated descriptions of the components are omitted.

The proposed features discussed below may be used separately or combined in any order. Some block diagrams shown in the accompany drawings are functional entities and do not necessarily correspond to physically or logically independent entities. Further, the embodiments may be implemented by processing circuitry (e.g., one or more processors or one or more integrated circuits) or implemented in the form of software, or implemented in different networks and/or processor apparatuses and/or microcontroller apparatuses. In one example, the one or more processors execute computer program code that is stored in a one or more non-transitory computer-readable media.

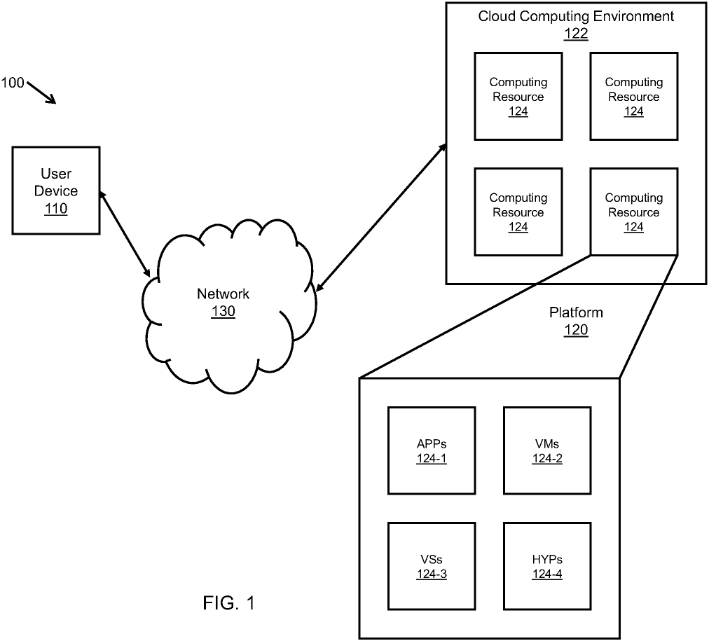

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 may include one or more devices capable of receiving, generating, storing, processing, and/or providing information associated with platform 120. For example, the user device 110 may include a computing device (e.g. a desktop computer, a laptop computer, a tablet computer, a handheld computer, a smart speaker, a server, etc.), a mobile phone (e.g. a smart phone, a radiotelephone, etc.), a wearable device (e.g. a pair of smart glasses or a smart watch), or a similar device. In some implementations, the user device 110 may receive information from and/or transmit information to the platform 120.

The platform 120 may include one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 may include an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 may include one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 may include a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 may include one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 may include a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 may include one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 may include one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

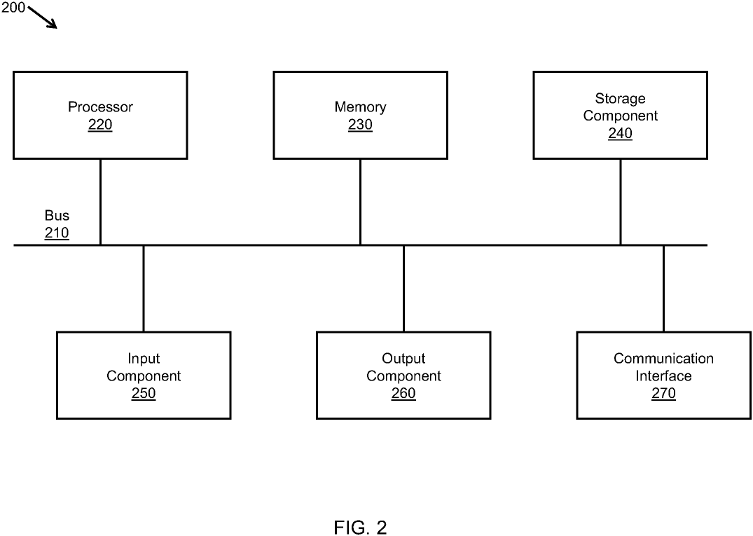

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 may be implemented in hardware, firmware, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 may include one or more processors capable of being programmed to perform a function. The memory 230 may include a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 may include a transceiver-like component (e.g. a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

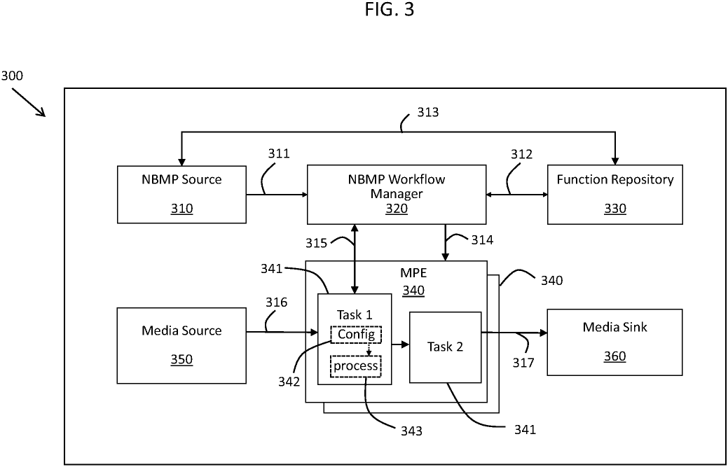

In an embodiment of the present disclosure, a Network-Based Media Processing (NBMP) system is provided. FIG. 3 illustrates a NBMP architecture 300 according to embodiments herein and may be implemented with respect to cloud processing. The NBMP system 300 comprises an NBMP source 310, an NBMP workflow manager 320, a function repository 330, one or more media processing entities (MPE) 340, a media source 350, and a media sink 360. The NBMP source 310, NBMP workflow manager 320, function repository 330, MPE 340, media source 350, and media sink 360 may include or be implemented by at least one or more processors and memory that store code configured to cause the at least one or more processors to perform the functions of the NBMP source 310, NBMP workflow manager 320, function repository 330, MPE 340, media source 360, and media sink 360, respectively.

The NBMP source 310 may communicate work flow descriptions with the NBMP workflow manager 320 via a NBMP workflow API 311. The NBMP source 310 may also communicate function descriptions with the function repository 330 via a function discovery API 313. For example, the NBMP source 310 may send workflow description document(s) (WDD) to the NBMP workflow manager 320, and may read the function description of functions stored in the function repository 330, the functions being media processing functions stored in memory of the function repository 330 such as, for example, functions of media decoding, feature point extraction, camera parameter extraction, projection method, seam information extraction, blending, post-processing, and encoding. The NBMP workflow manager 320 may communicate with the function repository 330 via a function discovery API 312, which may be a same or different API from the function discovery API 313, and may communicate with one or more of the MPE 340 via an API 314 (e.g. an MPE API).

The media processing entities 340 may include one or more tasks 341. The NBMP workflow manager 320 may also communicate with the tasks 341 via API 315 (e.g. an NBMP Task API). The NBMP workflow manager 320 may use the API 315 to setup, configure, manage, and monitor one or more tasks 341 of a workflow that is performable by the one or more MPE 340. In order to configure, manage, and monitor tasks 341 of the workflow, the NBMP workflow manager 320 may send messages, such as requests, to one or more of the MPE 340 and/ or the tasks 341, wherein each message may have several descriptors, each of which have several parameters. Additionally, the communications between the NBMP source 310, the NBMP workflow manager 320, the function repository 330, and the MPE 340 may be considered a control flow.

The tasks 341 may each include media processing functions 343 and configurations 342 for the media processing functions 343. Each of the tasks 341 in a respective media processing entity 340 may also communicate with each other facilitating data flow between tasks. In an embodiment, the NBMP workflow manager 320 may select the tasks based on the descriptions of the tasks in the WDD to search the function repository 330, via the function discovery API 312, to find the appropriate functions to run as tasks 341 for a current workflow. The one or more MPE 340 may be configured to receive media content from the media source 350, process the media content in accordance with the workflow, that includes tasks 341, created by the NBMP workflow manager 320, and output the processed media content to the media sink 360. In an embodiment, the one or more MPE 340 may be provided in parallel for multiple media flows 316 and 317 between the media source 350 and the media sink 360, respectively

The media source 350 may include memory that stores media and may be integrated with or separate from the NBMP source 310. In an embodiment, the NBMP workflow manager 320 may notify the NBMP source 310 when a workflow is prepared and the media source 350 may transmit media content to the one or more MPE 340 based on the notification that the workflow is prepared and the one or more MPE 340 may transmit the media content to the media sink 360. The communications between the media source 350, the MPE 340, and the media sink 360 may be considered a data flow.

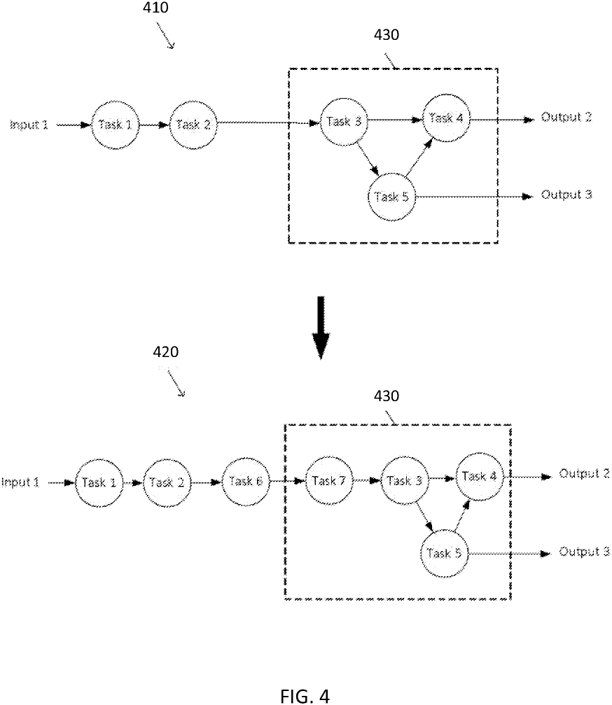

According to exemplary embodiments, when a workflow is split, a new task may be added to the original workflow to more efficiently split the workflow on a cloud platform. An example of such an addition will now be described, according to embodiments, with reference to FIG. 4.

A workflow may be changed by adding tasks to reduce the connection bandwidth of a device. As shown in FIG. 4, Task 6 and Task 7 are added to an initial workflow 410. In embodiments, the initial workflow 410 may be split between a cloud device and a sink device. The cloud device and the sink device may be the same or different from the media sink 360. For purposes of this example, the device will be referenced as the sink device 430. As the sink device 430 connection bandwidth reduces, the workflow 410 can work with the required throughput. The workflow manager (e.g., NBMP workflow manager 320) updates the workflow 410 by adding Task 6 and Task 7, resulting in a modified workflow 420. For example, Task 7 may be configured to perform a built-in decompression function in the sink device 430 and Task 6 may be configured to perform a compression function in the sink device 430. Using Task 6 as the compression function on the edge network, the bandwidth between Task 6 and Task 7 may be reduced enough to fit in the available bandwidth of the sink device 430. Task 6 and Task 7 have a net-zero impact on the workflow functionality. Thus, Task 6 and Task 7 do not impact the processing of the inputs (i.e., input 1) in generating the outputs (i.e., output 2 and output 3).

When a workflow is modified by adding new tasks, it is important to signal the existence of such tasks in the modified workflow. In the NBMP system, RESTFUL principles are used and therefore each resource shows the latest state of that resource. Each resource is complete and does not require other resources to show its properties. Additionally, the WDD shows the state of the workflow description. If a workflow is split and new tasks are added, as shown in FIG. 4, the WDD represents the status of the workflow but will not currently have any information about the added tasks. In embodiments, the workflow may be updated later by removing added tasks if necessary. However, the existence of the added tasks need to be signaled due to split-rendering properties and because the added tasks are not part of the original workflow. Therefore, signaling the added tasks in the modified workflow is beneficial.

In embodiments, Task Groups may be used to signal the collection of tasks and/or added tasks that can be removed from a workflow without impacting the functionality of the workflow. The advantage of this approach is that a different Task Group can be defined for each group. As such, there is a technical advantage to such features which allow for multiple net-zero groups to be signaled and one or more of those net-zero groups to be removed without removing other net-zero groups. Multiple net-zero groups may be removed at the same time or separately. In the NBMP standard, a task-group object defines the tasks that are in the same Task Group.

Table 1 shows an example of a task-group object according to the NBMP standard. The task-group object including parameters, parameter type, and cardinality.

TABLE 1

Task-Group Object

| Parameter Name | Type | Cardinality |
|---|---|---|
| group-id | P | 1 |
| task-id | Array of string | 1 |
| group-mode | P | 0-1 |

The task-group object parameters are defined in Table 2.

Table 2

Task-Group Parameter Definitions

| | | | | |
|---|---|---|---|---|
| Name | Definition | Unit | Type | Valid range |
| group-id | identifier of the Task Group This value should be unique among all Tasks' id and Task Group’s group-id. | N/A | string | N/A |
| task-id | The id of the task which is a member of this Task Group | N/A | string | N/A |
| group-mode | mode of running the tasks in this Task Group. The value ‘synchronous’ requires all Tasks of this Task Groups to be run at the same time. The value ‘asynchronous’ allows that each Task of this Task Group to be run independent than the other Tasks. The default is ‘synchronous’. | N/A | string | N/A |

In embodiments, a net-zero flag is added to the task-group object. Table 3 shows an example of a task-group object, with the added net-zero flag, according to one or more embodiments. In Table 3, and throughout the present disclosure, italics are used to show additions to the standard.

Table 3

Task-Group Object with Added Parameter

| Parameter Name | Type | Cardinality |
|---|---|---|
| group-id | P | 1 |
| task-id | Array of string | 1 |
| group-mode | P | 0-1 |
| net-zero | P | 0-1 |

The added net-zero parameter is defined in Table 4.

Table 4

Added Parameter Definition

| | | | | |
|---|---|---|---|---|
| Name | Definition | Unit | Type | Valid range |
| net-zero | If ‘true’, indicates all tasks in the task group may be removed from the workflow | N/A | boolean | N/A |
| | without workflow functionality is changing i.e., the workflow can be replaced with the resulting workflow. | | | |
| | If this flag exists, the Task Group is only defined for signaling this property, and other Task Group properties such as equal distance or group-mode are not relevant. | | | |

Modifying a workflow by adding tasks with net-zero functionality, the existence of the added tasks do not change the functionality of the entire workflow. The tasks are added for other purposes such as efficient splitting of the workflow. For each group of tasks whose existence provides a net-zero functionality, a task group can be added to the WDD of that workflow. The WDD may list the tasks' ids of that group and set the task group’s net-zero flag to ‘TRUE’. By setting the net-zero flag to ‘TRUE’, all tasks in the task group may be removed from the workflow without affecting the workflow functionality. In embodiments, the task groups are solely used for this purpose and do not indicate any grouping in terms of distance between tasks or task synchronization requirements.

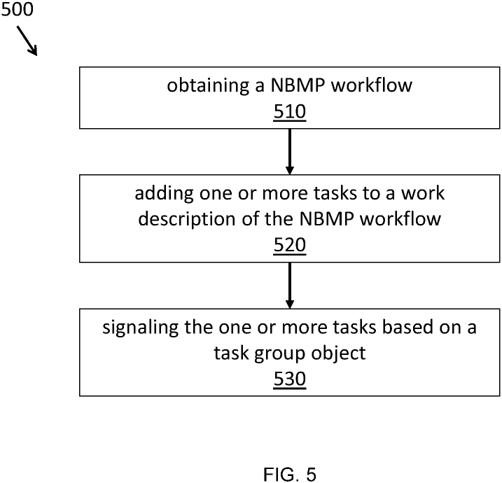

FIG. 5 is a flowchart of an example method 500 for signaling net-zero tasks in a modified workflow according to one or more embodiments.

In some implementations, one or more process blocks of FIG. 5 may be performed by the platform 120. In some implementations, one or more process blocks of FIG. 5 may be performed by another device or a group of devices separate from or including the platform 120, such as the user device 110.

As shown in FIG. 5, in operation 510, the method 500 includes obtaining a workflow.

In operation 520, the method 500 includes generating a modified workflow by adding one or more tasks to a work description of the workflow. The one or more tasks are configured to perform predetermined functions and a net effect of zero on the output of the workflow. That is, the one or more tasks do not change the output of the workflow or change the functionality of the workflow.

In operation 530, the method 500 includes signaling the one or more tasks of the modified workflow based on a task group object.

Although FIG. 5 shows example blocks of the method, in some implementations, the method may include additional blocks, fewer blocks, different blocks, or differently arranged blocks than those depicted in FIG. 5. Additionally, or alternatively, two or more of the blocks of the method may be performed in parallel.

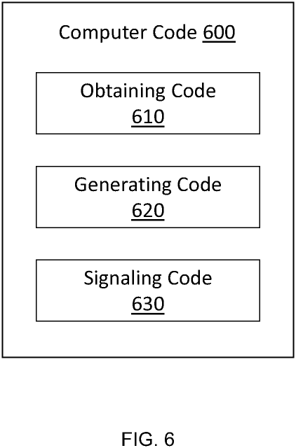

FIG. 6 is a block diagram of an example of computer code for signaling net-zero tasks in a modified workflow, according to one or more embodiments.

According to embodiments of the present disclosure, at least one processor with memory storing computer code may be provided. The computer code may be configured to, when executed by the at least one processor, perform any number of aspects of the present disclosure.

For example, with reference to FIG. 6, computer code 600 may be implemented in the NBMP system 300.

As shown in FIG. 6, the computer code 600 may include obtaining code 610, generating code 620, and signaling code 630.

The obtaining code 610 may be configured to cause the at least one processor to obtain a workflow.

The generating code 620 may be configured to cause the at least one processor to generate a modified workflow by adding one or more tasks to a work description of the workflow. The one or more tasks may be configured to perform predetermined functions and a net effect of zero on the output of the workflow. That is, the one or more tasks do not change the output of the workflow or change the functionality of the workflow.

The signaling code 630 may be configured to cause the at least one processor to signal the one or more tasks of the modified workflow based on a task group object.

Although FIG. 6 shows example blocks of the computer code 600 of an apparatus or device according to embodiments, in some implementations, the apparatus may include additional blocks, fewer blocks, different blocks, or differently arranged blocks than those depicted in FIG. 6. Additionally, or alternatively, two or more of the blocks of the apparatus may be combined.

The techniques for signaling net-zero tasks of a workflow on cloud platforms described above may be used separately or combined in any order. Further, each of the methods (or embodiments) may be implemented by processing circuitry (e.g., one or more processors or one or more integrated circuits). In one example, the one or more processors may execute a program that is stored in a non-transitory computer-readable medium.

The present disclosure provides illustration and description, but is not intended to be exhaustive or to limit the implementations to the precise form disclosed. Modifications and variations are possible in light of the present disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein may be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for signaling network based media processing (NBMP) workflow modifications when a workflow split is required, performed by at least one processor, the method comprising:
obtaining a NBMP workflow;
generating a modified NBMP workflow by adding one or more tasks to a work description of the NBMP workflow; and
signaling the one or more tasks of the modified NBMP workflow based on a task group object,
wherein the one or more tasks are configured to perform predetermined functions, and the one or more tasks do not change an output of the NBMP workflow.

2. The method of claim 1, further comprising:
determining the one or more tasks included in a task group based on the task group object, the task group object comprising a group identification, a task identification, a group mode, and a net-zero flag.

3. The method of claim 2, further comprising:
based on a status of the net-zero flag, removing the one or more tasks in the task group from the modified NBMP workflow, wherein the removing of the one or more tasks does not change an output of the modified NBMP workflow.

4. The method of claim 3, wherein the NBMP workflow is replaced by the modified NBMP workflow.

5. The method of claim 2, wherein the one or more tasks in the task group are signaled at the same time, based on the group mode.

6. The method of claim 2, wherein the one or more tasks in the task group are signaled independently, based on the group mode.

7. The method of claim 2, wherein the group identification uniquely identifies the task group and the task identification identifies the one or more tasks included in the task group.

8. The method of claim 1, wherein the modified NBMP workflow includes one or more task groups, the one or more task groups do not change the output of the NBMP workflow, and the one or more task groups are removed at the same time or independently.

9. An apparatus for signaling network based media processing (NBMP) workflow modifications when a workflow split is required, the apparatus comprising:
at least one memory configured to store program code; and
at least one processor configured to read the program code and operate as instructed by the program code, the program code including:
obtaining code configured to cause the at least one processor to obtain a NBMP workflow;
generating code configured to cause the at least one processor to generate a modified NBMP workflow by adding one or more tasks to a work description of the NBMP workflow; and
signaling code configured to cause the at least one processor to signal the one or more tasks of the modified NBMP workflow based on a task group object,
wherein the one or more tasks are configured to perform predetermined functions, and the one or more tasks do not change an output of the NBMP workflow.

10. The apparatus of claim 9, wherein the computer program code further comprises determining code configured to cause the at least one processor to determine the one or more tasks included in a task group based on the task group object, the task group object comprising a group identification, a task identification, a group mode, and a net-zero flag.

11. The apparatus of claim 10, wherein the computer program code further comprises, based on a status of the net-zero flag, removing code configured to cause the at least one processor to remove the one or more tasks in the task group from the modified NBMP workflow, wherein the removing of the one or more tasks does not change an output of the modified NBMP workflow.

12. The apparatus of claim 11, wherein the NBMP workflow is replaced by the modified NBMP workflow.

13. The apparatus of claim 10, wherein the one or more tasks in the task group are signaled at the same time, based on the group mode.

14. The apparatus of claim 10, wherein the one or more tasks in the task group are signaled independently, based on the group mode.

15. The apparatus of claim 10, wherein the group identification uniquely identifies the task group and the task identification identifies the one or more tasks included in the task group.

16. The apparatus of claim 9, wherein the modified NBMP workflow includes one or more task groups, the one or more task groups do not change the output of the NBMP workflow, and the one or more task groups are removed at the same time or independently.

17. A non-transitory computer readable medium storing instructions, the instructions comprising: one or more instructions that, when executed by at least one processor of an apparatus for signaling network based media processing (NBMP) workflow modifications when a workflow split is required, cause the at least one processor to:
obtain a NBMP workflow;
generate a modified NBMP workflow by adding one or more tasks to a work description of the NBMP workflow; and
signal the one or more tasks of the modified NBMP workflow based on a task group object,
wherein the one or more tasks are configured to perform predetermined functions, and the one or more tasks do not change an output of the NBMP workflow.

18. The non-transitory computer readable medium of claim 17, wherein the instructions further cause the at least one processor to determine the one or more tasks included in a task group based on the task group object, the task group object comprising a group identification, a task identification, a group mode, and a net-zero flag,
wherein the group identification uniquely identifies the task group, the task identification identifies the one or more tasks included in the task group, and the group mode indicated whether the one or more tasks in the task group are signaled at the same time or independently.

19. The non-transitory computer readable medium of claim 17, wherein the instructions further cause the at least one processor to, based on a status of the net-zero flag , remove the one or more tasks in the task group from the modified NBMP workflow,
wherein the removing of the one or more tasks does not change an output of the modified NBMP workflow, and the NBMP workflow is replaced by the modified NBMP workflow.

20. The non-transitory computer readable medium of claim 17, wherein the modified NBMP workflow includes one or more task groups, the one or more task groups do not change the output of the workflow, and the one or more task groups are removed at the same time or independently.
